(19) United States
(12) Patent Application Publication
(10) Pub. No.: US 2013/0237355 A1
(43) Pub. Date: Sep. 12, 2013

(54) LOW-NOISE BELT DRIVE

(71) Applicant: Thomas Lubojatzky, Stuttgart (DE)

(72) Inventor: Thomas Lubojatzky, Stuttgart (DE)

(73) Assignee: ThyssenKrupp Presta AG, Eschen (LI)

(21) Appl. No.: 13/881,438

(22) PCT Filed: Nov. 10, 2011
(86) PCT No.: PCT/EP2011/005651

§ 371 Date: Apr. 25, 2013

(30) Foreign Application Priority Data
Nov. 10, 2010 (DE) 10 2010 050 783.0

(51) Int. Cl. F16H 7/02

(52) U.S. Cl. CPC F16H 7/023
USPC 474/148

(57) ABSTRACT

The invention relates to electromechanical power-assisted steering for motor vehicles, having a steering gear in which a belt drive is provided for power transmission between a servomotor and a gear transmission and which comprises a toothed belt and two belt pulleys coupled by means of the toothed belt, wherein the toothed belt, transversely to its running direction, has a concave internal contour, viewed from the belt pulley, and in that corresponding belt pulleys are provided transversely to the direction of rotation with a corresponding convex external contour.

The present invention relates to electromechanical power-assisted steering having the features of the pre-characterising clause of claim 1.

In electromechanical power-assisted steering toothed belt drives are preferably used where a high level of support and low noise emission are required. An example of such steering is known by way of example from document DE 10 2007 004 521 A1. The toothed belt drive connects the output shaft of an electric motor to the input shaft of a gear transmission such that the rotational movement is converted into a linear movement of a rack. A ball screw is conventionally used here. The conventional design of the toothed belt drive provides that the belt is provided on its inner side with teeth arranged transversely to the running direction and these mesh with corresponding grooves on the belt pulley. The envelope of the belt pulley is exactly cylindrical, so the toothed belt is not fixed in the axial direction of the two shafts. To prevent shifting of the toothed belt on the discs the smaller belt pulley is outwardly provided with what are known as flanged discs which limit shifting of the toothed belt in the axial direction.

In belt drives of this kind vibrations of the belt occur which are produced by the teeth provided at regular intervals transversely to the running direction. At certain rotational speeds of the belt drive the belt can be caused to vibrate by the contour of the belt pulley. Great efforts are therefore being made to make a belt drive of this kind of a low-noise character. The conventional measures relate to the form of the individual teeth on the inner side of the toothed belt and their orientation. Toothed belts by way of example are also known therefore which have a herringbone gearing. In this connection the two sections of an arrow-shaped tooth can also be mutually offset in the running direction of the toothed belt. Toothed belts of this kind are very expensive. The matching belt pulleys are similarly very expensive to produce.

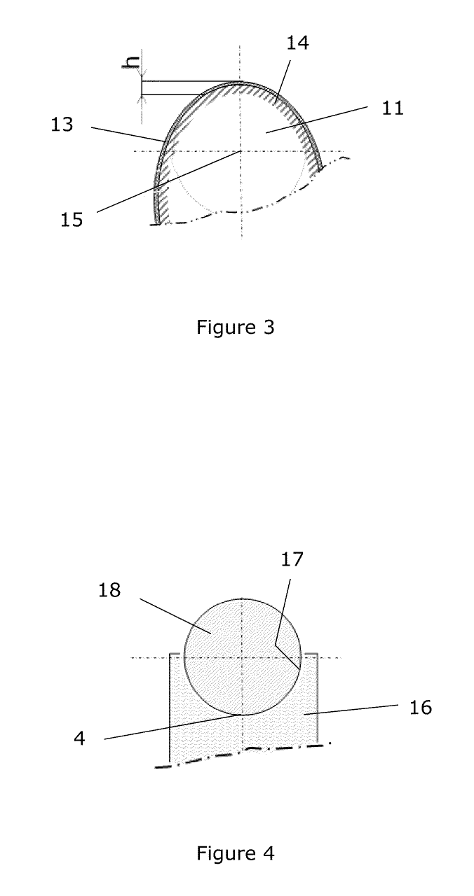

Document BE 520 967 A relates to an endless gear having rollers via which a belt, which automatically centres itself, is tensioned. FIGS. 3 to 8 show various rollers with corresponding belts, wherein FIG. 6 shows a roller with convex external contour and a belt with a concave internal contour.

It is therefore the object of the present invention to improve generic power-assisted steering in relation to its noise emission.

This object is achieved by power-assisted steering having the features of claim 1.

Because in the case of a belt drive with a belt, which, transversely to its running direction, has a concave internal contour, viewed from the direction of the belt pulley, and with corresponding belt pulleys, which are provided transversely to the rotational direction with a corresponding convex external contour, an edge region of the belt outwardly encompasses the convex external contour of the belt pulley, the tendency of the belt to vibrate in the region of its free sides is reduced. The flexural stiffness of the belt is increased. If the belt is a toothed belt and the belt pulleys are matching toothed belt discs, the stimulation of the belt when a tooth strikes the corresponding groove in the belt pulley is less pronounced.

In a preferred embodiment the flanged discs for centring the toothed belt may be omitted. Potential kinematic problems, which could occur owing to the different circumferential speeds of the belt wheels in the axial direction of the teeth, can be compensated by an enlarged face clearance between the tooth and the groove in the edge region. It may also be provided that the edge region is designed free of teeth.

Particularly good suppression of the tendency to vibrate is achieved if in the edge region the toothed belt has inwardly-pointing, encircling ribs which engage in correspondingly freed regions of the belt pulley or outwardly encompass the belt pulley.

Exemplary embodiments of the present invention will be described in more detail below with the aid of the drawings, in which:

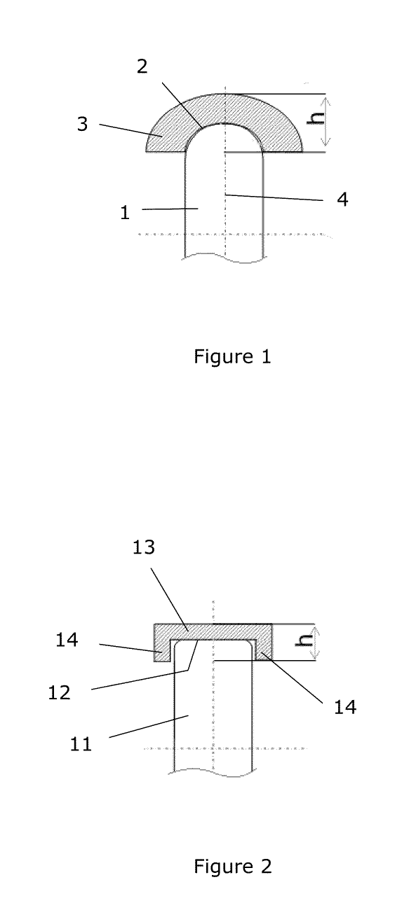

FIG. 1: shows a cross-section through a belt pulley with convex external profile and a corresponding belt in a schematic diagram;

FIG. 2: shows a cross-section through a belt pulley with roughly rectangular cross-section and a belt which comprises inwardly-pointing guide ribs;

FIG. 3: shows a schematic side view of a belt drive using the belt from FIG. 2; and

FIG. 4: shows a cross-section through a belt pulley with a concave, roughly semi-circular running surface and a belt with a round cross-sectional profile.

FIG. 1 shows a cross-section [of] a belt pulley 1 which has an outer convex running surface 2 for a corresponding concave toothed belt 3. The toothed belt 3 is provided in a central region close to a plane of symmetry 4, which is perpendicular to the drawing plane, with teeth which engage positively and without clearance in corresponding teeth of the belt pulley 1. To the right and left of the plane 4 the toothed belt 3 is pulled around the convex region 2 of the belt pulley 1. The toothed belt 3 thus automatically centres itself on the belt pulley 1 during rotation. A second belt pulley with a different diameter is provided with a corresponding contour. A characteristic feature is that the conventionally required lateral flanged discs can be omitted due to the contour of the toothed belt 3 and that the illustrated cross-sectional contour of the belt with the height a indicated in FIG. 1 ensures particular stability with respect to induced vibrations perpendicular to the running direction in the region of the free sides of the belt, thus minimising noise emission.

FIG. 2 shows in a corresponding diagram another belt pulley 11 which has a substantially rectangular cross-section. An outer circumferential surface 12 is provided with teeth which mesh with corresponding teeth of a belt 13. The belt 13 is fitted with ribs 14 on the side and these project parallel to its direction of rotation inwardly over the plane of the teeth. On the one hand the ribs 14 centre the belt 13 on the belt pulley 11 and on the other hand the ribs 14 stiffen the belt 13, so minimisation of noise emission is in turn achieved.

The ribs 14 form an edge region of the belt which outwardly encompasses the convex external contour of the belt pulley.

FIG. 3 shows the arrangement from FIG. 2 in a side view. The belt pulley 11 is round and mounted so as to rotate about a centre of rotation 15. The belt 13 is guided over the belt pulley 11. The ribs 14 overlap the belt pulley 11 laterally by an amount which matches the illustrated height a.

Finally FIG. 4 shows a belt pulley 16 which on its outer circumferential surface has a concave recess 17 with roughly semi-circular cross-section. A circular belt 18 is placed over the belt pulley 16. The circular belt 18 is provided with teeth in the region of the plane 4, which is the plane of symmetry of the belt pulley 16 and of the belt 18, and the teeth engage in correspondingly compatible teeth on the belt pulley 16.

Due to the teeth, the illustrated belt designs can be placed in a belt drive so as to be slip-free. The contour of the belt suppresses natural vibrations in the regions between the two belt pulleys. In the edge region the belt can have a certain elasticity which supports the encircling process of the belt when it engages with the belt pulleys. For this purpose it may be provided that highly tensile, non-lengthenable fibres are provided only in the centre of the belt 3 or 13, i.e. where the teeth are arranged in the region of the plane 4.

It may also be provided that, in particular in the case of the embodiment according to FIG. 1, the teeth are guided over the entire convex surface 2 of the belt pulley 1. It is then advantageous to provide the teeth with a certain clearance in the edge regions by way of appropriate design of the grooves on the belt pulley 1 or the teeth on the inner side of the belt 3, which play allows the required deformation. In the case of low heights a in the region of a few millimetres it may also be provided that the profile shift of the teeth varies from the centre of the plane 4 to the edges.

Overall the illustrated belt designs make it possible to construct a belt drive in electromechanical motor vehicle power-assisted steering without the conventional flanged discs and to consequently save space in the radial direction of the belt pulleys. In addition, the noise emission of the belt drive is minimised by the increased flexural stiffness of the illustrated belt.

1. An electromechanical power-assisted steering for motor vehicles, having:
a steering gear in which a belt drive is provided for power transmission between a servomotor and a gear transmission, and which comprises a belt and two belt pulleys coupled by means of the belt, wherein the belt, transversely to its running direction, has a concave internal contour, viewed from one of the belt pulleys, wherein corresponding belt pulleys are provided transversely to a direction of rotation with a corresponding convex external contour, and wherein an edge region of the belt encompasses the convex external contour of the belt pulley from the outside.

2. The power-assisted steering according to claim 1, wherein the belt is a toothed belt.

3. The power-assisted steering according to claim 1, wherein the belt pulleys do not comprise flanged discs.

4. The power-assisted steering according to claim 1, wherein an enlarged face clearance is provided between a tooth and a groove in an edge region.

5. The power-assisted steering according to claim 1, wherein an edge region of the belt pulleys and/or the belt is free of teeth.

6. The power-assisted steering according to claim 2, wherein, in an edge region, the toothed belt comprises inwardly-pointing, encircling ribs which engage in correspondingly freed regions of the belt pulley or outwardly encompass the belt pulley.
